(19) United States
(12) Patent Application Publication
(10) Pub. No.: US 2026/0032376 A1
(43) Pub. Date: Jan. 29, 2026

(54) SPEAKER

(71) Applicant: AAC Microtech (Changzhou) Co., Ltd., Changzhou City (CN)

(72) Inventors: Weimin Chen, Changzhou (CN); Yao Hui, Changzhou (CN)

(21) Appl. No.: 19/001,345

(22) Filed: Dec. 24, 2024

Related U.S. Application Data
(63) Continuation of application No. PCT/CN2024/107181, filed on Jul. 24, 2024.

(51) Int. Cl. H04R 1/28; H04R 7/12; H04R 9/02; H04R 9/06

(52) U.S. Cl. CPC H04R 1/288; H04R 7/127; H04R 9/025; H04R 9/06; H04R 2400/11; H04R 2499/11

(57) ABSTRACT

The present invention relates to the technical field of electroacoustic conversion and provides a speaker, the speaker of the present invention connects a magnetic yoke and a basin frame through an elastic connection member to support a magnetic circuit system in vibration, a diaphragm, the magnetic yoke, the basin frame, and an elastic connection member together form a sealed back cavity. The vibration directions of the magnetic circuit system and the vibration system are in opposite directions. An upper housing and a lower housing are respectively fixed to the opposite sides of the basin frame, the upper housing, the diaphragm, and the basin frame together form a first front cavity for sound output, and the lower housing, the magnetic yoke, and the basin frame together form a second front cavity for sound output, so as to realize dual-sided sound output from the speaker.

### CROSS-REFERENCE TO RELATED APPLICATIONS

This application is a continuation of International Application No. PCT/CN2024/107181, filed on Jul. 24, 2024, the entire content of which is incorporated herein by reference.

### TECHNICAL FIELD

The present invention relates to the technical field of electroacoustic conversion, and in particular to a speaker.

### BACKGROUND

With the advent of the mobile Internet era, the number of smart mobile devices continues to rise. Among many mobile devices, mobile phones are undoubtedly the most common and portable mobile terminal device. However, for the current mobile phone speaker, when the excitation voltage is high, the phenomenon of shell vibration is often very severe, which provides a poor user experience. Additionally, the enhancement of frequency response sensitivity has always been the pursuit for miniature speakers.

Therefore, there is necessary to provide a new speaker to solve the aforementioned technical problems.

### SUMMARY

The purpose of the present invention is to provide a speaker with high reliability and good user experience.

The technical solution of the present invention is as follows.

The present invention provides a speaker, including a basin frame, a vibration system and a magnetic circuit system respectively fixed to the basin frame, the magnetic circuit system configured for driving the vibration system to vibrate and produce sound, the vibration system including a diaphragm fixed to the basin frame, and the magnetic circuit system including a magnetic yoke supported by and fixed to the basin frame. An elastic connection member connecting the magnetic yoke and the basin frame to support the vibration of the magnetic circuit system, the diaphragm, the magnetic yoke, the basin frame, and the elastic connection member being sealed and surrounded to form a back cavity. Vibration directions of the magnetic circuit system and the vibration system being opposite. An upper housing and a lower housing respectively fixed on opposite sides of the basin frame, the upper housing, the diaphragm, and the basin frame cooperatively forming a first front cavity for sound output, and the lower housing, the magnetic yoke, and the basin frame cooperatively forming a second front cavity for sound output.

Preferably, the upper housing is provided with a first sound outlet for connecting the first front cavity to the outside world, the lower housing is connected to the upper housing, and the upper housing and the lower housing cooperatively form a second sound outlet for connecting the second front cavity to the outside.

Preferably, the clastic connection member includes a first fixed connection portion connected to the magnetic yoke, an elastic portion extending from the periphery of the first fixed connection portion, a second fixed connection portion bending and extending from the side of the clastic portion away from the first fixed connection portion, and the second fixed connection portion is connected to the basin frame.

Preferably, the clastic connection member is made of one or more of a monomer damping material, a polymer composite damping material, and a metal composite damping structure.

Preferably, the magnetic circuit system includes a main magnet fixed to the magnetic yoke, a secondary magnet spaced apart from the main magnet to form a magnetic gap, a main pole plate covering the side of the main magnet away from the magnetic yoke; the main magnet is penetrated at a center thereof to form a first cavity, the main pole plate is penetrated at a center thereof to form a second cavity, the first cavity and the second cavity are connected; the magnetic circuit system further includes a magnetic assembly at least partially received in the first cavity, and a connection element connects the magnetic assembly and the diaphragm via the second cavity.

Preferably, the magnetic yoke is penetrated at a center thereof to form an opening hole, and the first cavity, the second cavity, and the opening hole are coaxially arranged.

Preferably, the magnetic assembly includes a first magnetic part received in the first cavity and is connected to the side of the connection element away from the diaphragm.

Preferably, the magnetic assembly includes a second magnetic part fixed to the magnetic yoke and located in the first cavity; the second magnetic part is penetrated to form a third cavity, the third cavity is coaxially arranged with the second cavity; and the first magnetic part is received in the third cavity and is spaced apart from the second magnetic part.

Preferably, the connection element is made of a non-magnetic conductive material.

Preferably, the first magnetic part is a magnet, and the second magnetic part is the magnet, a magnetic portion, a magnetic conductive material or a structure formed by alternating layers of magnetic conductive material and non-magnetic conductive material.

Preferably, the basin frame includes a body portion having a receiving space, and an extension portion received in the receiving space and extending from the body portion, the magnetic yoke and the diaphragm are fixed to the basin frame at opposite ends along the vibration direction of the vibration system, and the extension portion covers the side of the secondary magnet away from the magnetic yoke.

The beneficial effect of the present invention are as follows: The speaker of the present invention connects a magnetic yoke and a basin frame through an elastic connection member to support a magnetic circuit system in vibration, a diaphragm, the magnetic yoke, the basin frame, and an elastic connection member together form a sealed back cavity; the vibration directions of the magnetic circuit system and the vibration system are in opposite directions; an upper housing and a lower housing are respectively fixed to the opposite sides of the basin frame, the upper housing, the diaphragm, and the basin frame together form a first front cavity for sound output, and the lower housing, the magnetic yoke, and the basin frame together form a second front cavity for sound output, so as to realize dual-sided sound output from the speaker, and enhance the sensitivity of sound output, the vibration of the magnetic circuit system and the vibration system together form two suspension systems, which are subject to exert forces and the direction of the force is opposite to each other, when the speaker is connected to a terminal device, the force is reduced, which has a certain vibration reduction effect, thus avoiding the appearance of shell vibration problem.

### BRIEF DESCRIPTION OF THE DRAWINGS

FIG. 1 is a perspective structural diagram of a speaker according to an embodiment of the present invention;

FIG. 2 is an exploded structural diagram of the speaker according to an embodiment of the present invention;

FIG. 3 is a sectional view of FIG. 1 along line A-A;

FIG. 4 is a partial enlarged structural diagram of region B in FIG. 2;

FIG. 5 is a partial enlarged structural diagram of region C in FIG. 3;

FIG. 6 is an assembly structural diagram of the magnetic circuit system according to an embodiment of the present invention;

FIG. 7 is another sectional view of FIG. 1 along line A-A; and

FIG. 8 is an assembly structural diagram of the upper housing and the lower housing according to an embodiment of the present invention.

### DETAILED DESCRIPTION OF THE EMBODIMENTS

The present invention is further described below in detail in combination with the accompanying drawings and embodiments.

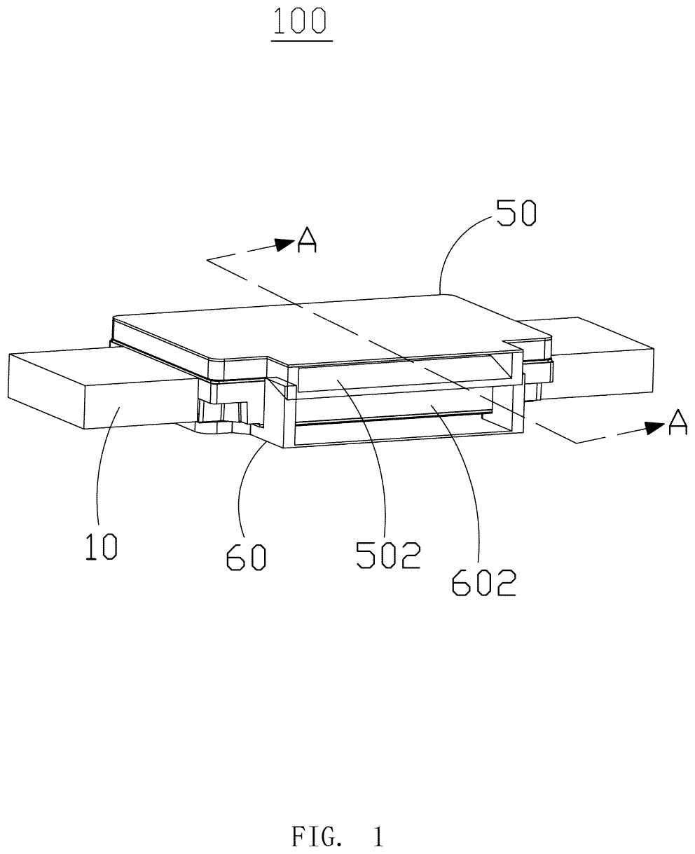

Please refer to FIG. 1 to FIG. 3. The speaker 100 according to an embodiment of the present invention includes a basin frame 10, a vibration system 20, a magnetic circuit system 30, an clastic connection member 40, an upper housing 50, and a lower housing 60.

The basin frame 10 is used to support the vibration system 20 and the magnetic circuit system 30. The magnetic circuit system 30 has a magnetic gap 301, the magnetic circuit system 30 is used to drive the vibration system 20 to vibrate and produce sound. In this embodiment, the basin frame 10 is rectangular in shape. The basin frame 10 includes a body portion 11 having a receiving space 101, and an extension portion 12 received in the receiving space 101 and extending from the body portion 11.

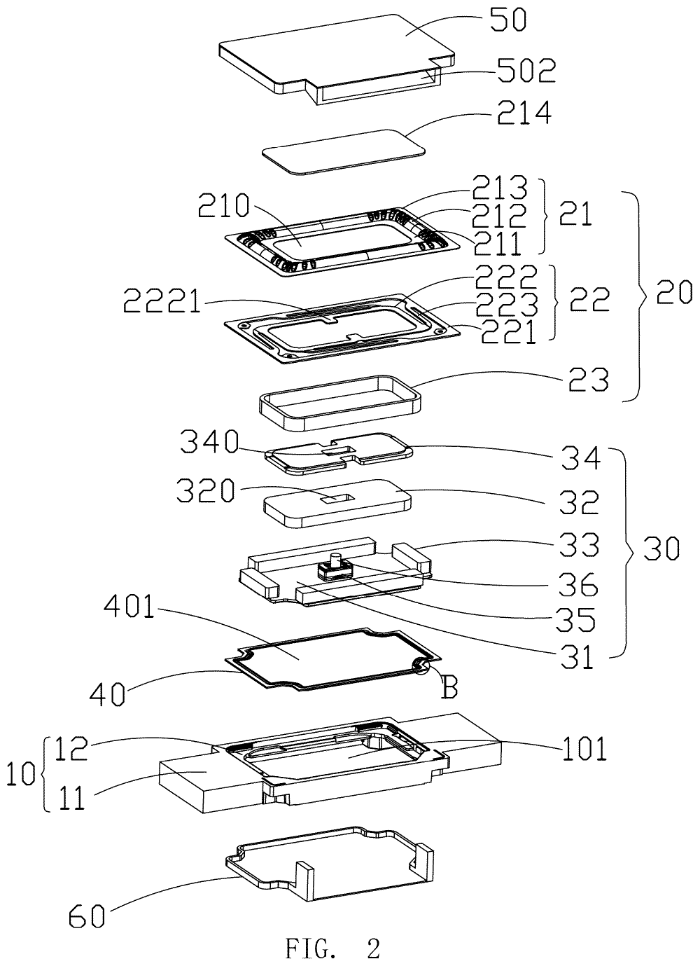

Please refer to FIG. 2, the vibration system 20 includes a diaphragm 21 fixed on the basin frame 10, a former 22 fixed on the side of the diaphragm 21 toward the magnetic circuit system 30, a voice coil 23 supported in the magnetic gap 301 by the former 22. When the speaker 100 is connected to a power supply, the voice coil 23 vibrates interacts with the magnetic circuit system 30, thereby driving the diaphragm 21 to vibrate and produce sound.

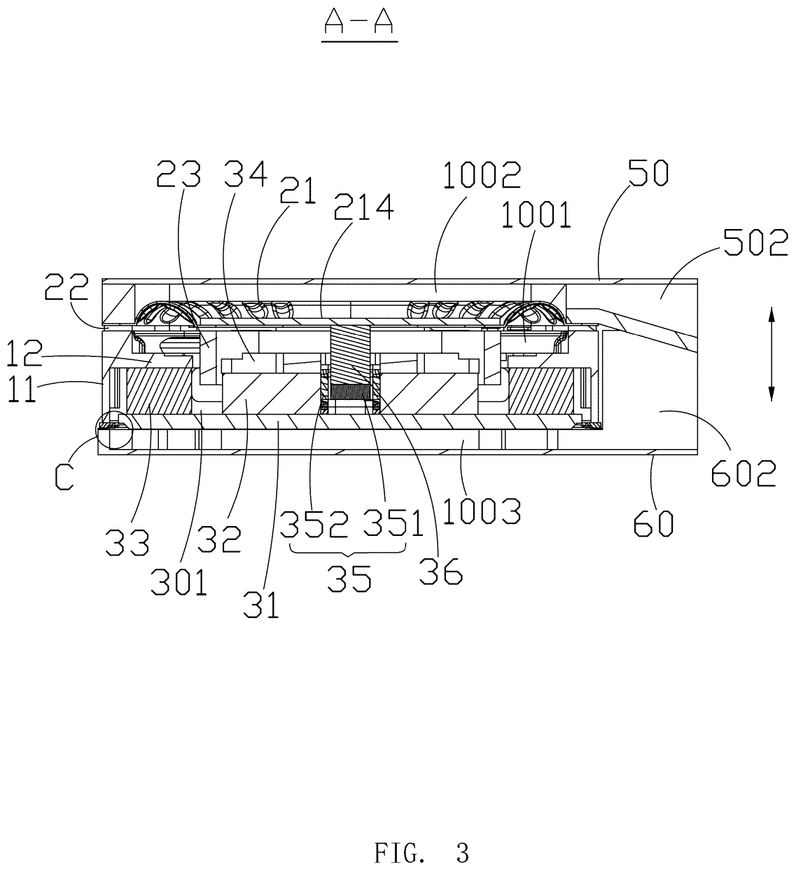

Specifically, please refer to FIGS. 2 and 3, the diaphragm 21 includes a vibration portion 211, a ring part 212 that is bent and extends from the periphery of the vibration portion 211, a fixing portion 213 that is bent and extends outwardly from the side of the a ring part 212 away from the vibration portion 211, a through opening 210 penetrates through the vibration portion 211 along the vibration direction (see the arrow direction shown in FIG. 3) of the diaphragm 21, and a dome 214 arranged on the vibration portion 211 and covers the through opening 210 completely. The fixing portion 213 is fixed to the basin frame 10 through the former 22, the ring part 212 are arc-shaped structures protruding towards the side away from the magnetic circuit system 30. In other embodiments, the diaphragm 21 may not have a through opening 210, and the dome 214 can be directly fixed to the diaphragm 21. The a ring part 212 of the diaphragm 21 can also be arc-shaped structures protruding towards the side of the magnetic circuit system 30, which may be selected as specifically desired.

Please refer to FIGS. 2 and 3, the diaphragm 21 is attached to the side of the former 22 that is away from the magnetic circuit system 30, and the voice coil 23 is attached to the side of the former 22 that is facing the magnetic circuit system 30, as well as the basin frame 10. Specifically, the former 22 includes a first connection portion 221 for connecting to the basin frame 10, a second connection portion 222 for connecting to the voice coil 23, and a connection arm 223 connects the first connection portion 221 and the second connection portion 222. The second connection portion 222 partially protrudes on the side away from the first connection portion 221 to form a suspension arm 2221. The former 22 can be a circuit board, through the former 22, an electrical signal can be introduced to the voice coil 23.

Please refer to FIGS. 2, 3, and 6, the magnetic circuit system 30 includes a magnetic yoke 31 supported by and fixed to the basin frame 10, a main magnet 32 fixed to the magnetic yoke 31, a secondary magnet 33 is spaced apart from the main magnet 32 to form the magnetic gap 301, and a main pole plate 34 covers the side of the main magnet 32 away from the magnetic yoke 31.

Please refer to FIG. 2, the main magnet 32 is formed with a first cavity 320 through at the center.

Please refer to FIG. 2, the main pole plate 34 is used for magnetic conduction to enhance driving force. The main pole plate 34 is formed with a second cavity 340 through at the center, and the first cavity 320 and the second cavity 340 are connected. Preferably, the first cavity 320 and the second cavity 340 are coaxially arranged.

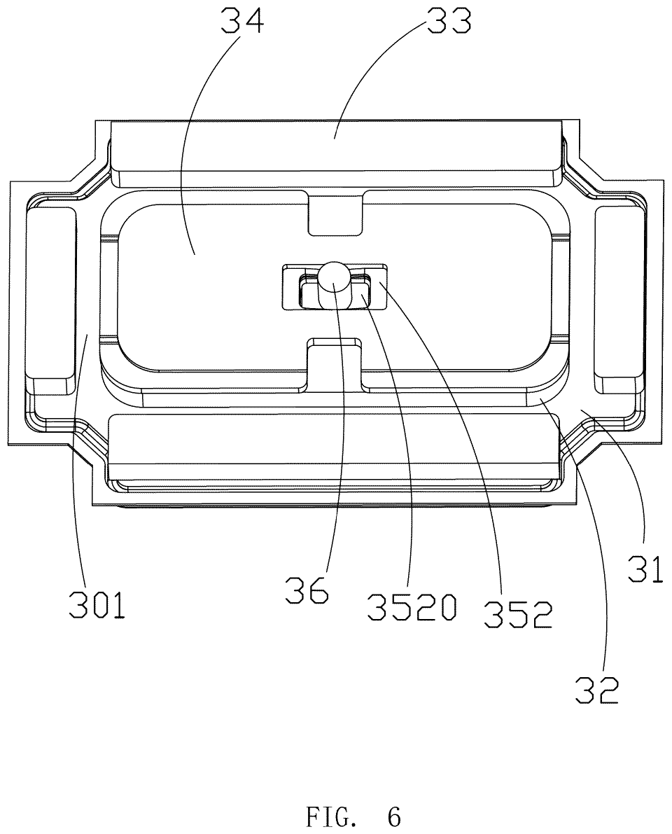

Please refer to FIGS. 3 and 6, the magnetic yoke 31 can be used for magnetic conduction to enhance driving force. The magnetic yoke 31 fixes the main magnet 32 and the secondary magnet 33, the secondary magnet 33 surrounds the circumference of the main magnet 32. The magnetic yoke 31 and the diaphragm 21 are fixed to the basin frame 10 at opposite ends along the vibration direction of the vibration system 20, the extension portion 12 covers the side of the secondary magnet 33 away from the magnetic yoke 31, in the case when the extension portion 12 is made of a magnetic conductive material, the extension portion 12 can serve as a magnetic conductive plate.

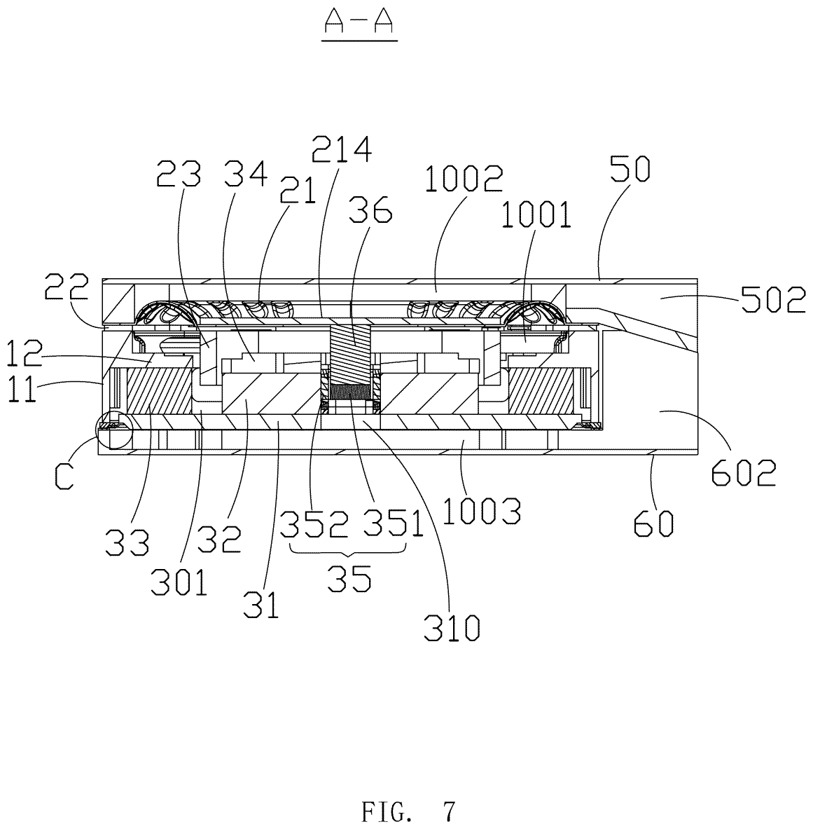

Further, please refer to FIG. 7. The magnetic yoke 31 is formed with an opening hole 310 through the center, and the first cavity 320, the second cavity 340, and the opening hole 310 are coaxially arranged. This embodiment adjusts the negative stiffness nonlinearity by setting the opening hole 310 at the center of the magnetic yoke 31.

Further, please refer to FIGS. 2, 3, and 6. The magnetic circuit system 30 also includes a magnetic assembly 35 at least partially received in the first cavity 320, and a connection element 36 connects the magnetic assembly 35 and the diaphragm 21 via the second cavity 340.

In this embodiment, please refer to FIG. 3, by adding the magnetic assembly 35 and the connection element 36 to the magnetic circuit system 30, the magnetic assembly 35 and the dome 214 are connected by the connection element 36, when the diaphragm 21 is located at in the initial position, the additional magnetic assembly 35 and the electromagnetic assembly (including the main magnet 32, the secondary magnet 33, and the main pole plate 34) does not exert force on the vibration area; during the vibration of the diaphragm 21, the force exerted by the magnetic assembly 35 and the electromagnetic assembly on the vibration area is in the same direction as the vibration displacement, i.e., to provide negative stiffness to the speaker 100, to enhance the amplitude of the suspension of the vibration system 20 and the suspension of the magnetic circuit system 30, and to further increase the low-frequency sensitivity of the dual-sided sound output.

Please refer to FIGS. 2 and 3, the magnetic assembly 35 includes a first magnetic part 351 received within the first cavity 320 and connected to the side of the connection element 36 away from the diaphragm 21.

Please refer to FIGS. 2, 3, and 6, the magnetic assembly 35 also includes a second magnetic part 352 fixed to the magnetic yoke 31 and located in the first cavity 320; the second magnetic part 352 is penetrated to form a third cavity 3520, and the third cavity 3520 is coaxially arranged with the second cavity 340; and the first magnetic part 351 is received within the third cavity 3520 and is spaced apart from the second magnetic part 352.

Preferably, the first magnetic part 351 is a magnet, and the second magnetic part 352 is a magnet, a magnetic portion, or a structure formed by alternating layers of magnetic conductive material and non-magnetic conductive material. The connection element 36 is made of a non-magnetic material.

In this embodiment, by setting the second magnetic part 352 based on the first magnetic part 351 can further adjust the nonlinearity of the negative stiffness of the speaker 100, making the negative stiffness more symmetrical. Thereby, the low-frequency resonance of the speaker 100 is improved, and the speaker distortion is reduced.

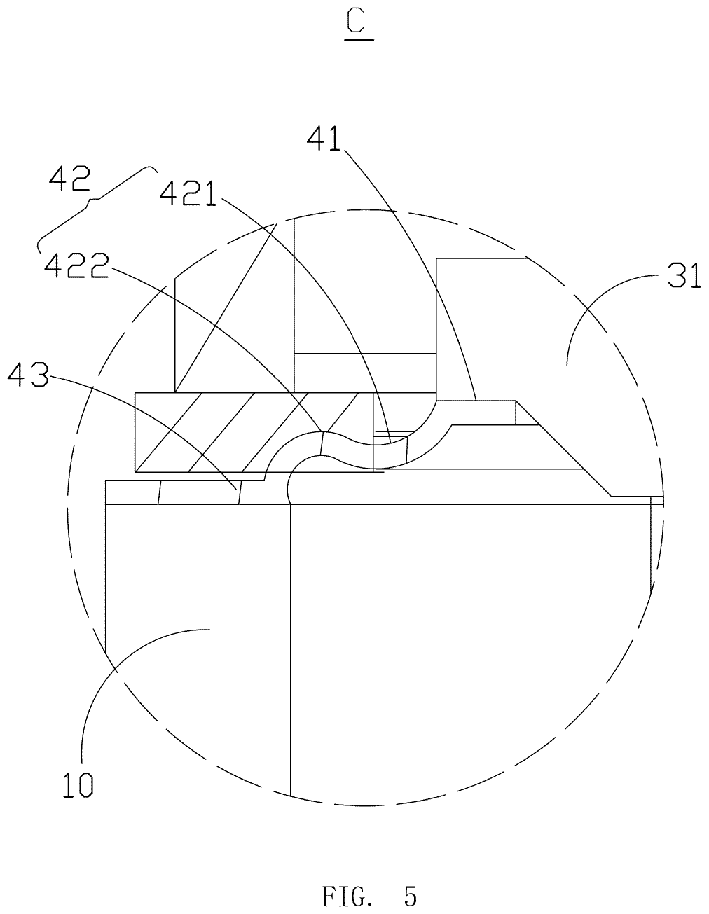

Please refer to FIGS. 3 and 5. The clastic connection member 40 is fixed to the magnetic yoke 31, and the magnetic yoke 31 is connected to the basin frame 10 by the elastic connection member 40, the diaphragm 21, the magnetic yoke 31, the basin frame 10, and the clastic connection member 40 cooperatively form a sealed back cavity 1001.

Specifically, please refer to FIG. 2 to FIG. 5, the clastic connection member 40 includes a first fixed connection portion 41 connected to the magnetic yoke 31, an elastic portion 42 extending from the periphery of the first fixed connection portion 41, and a second fixed connection portion 43 bending and extending from the side of the elastic portion 42 away from the first fixed connection portion 41; the second fixed connection portion 43 is connected to the basin frame 10. The clastic portion 42 can be an arc-shaped structure protruding towards the magnetic circuit system 30 or away from the magnetic circuit system 30, or the cross-section of the elastic portion 42 can be W-shaped, C-shaped, or S-shaped, depending on specific requirements.

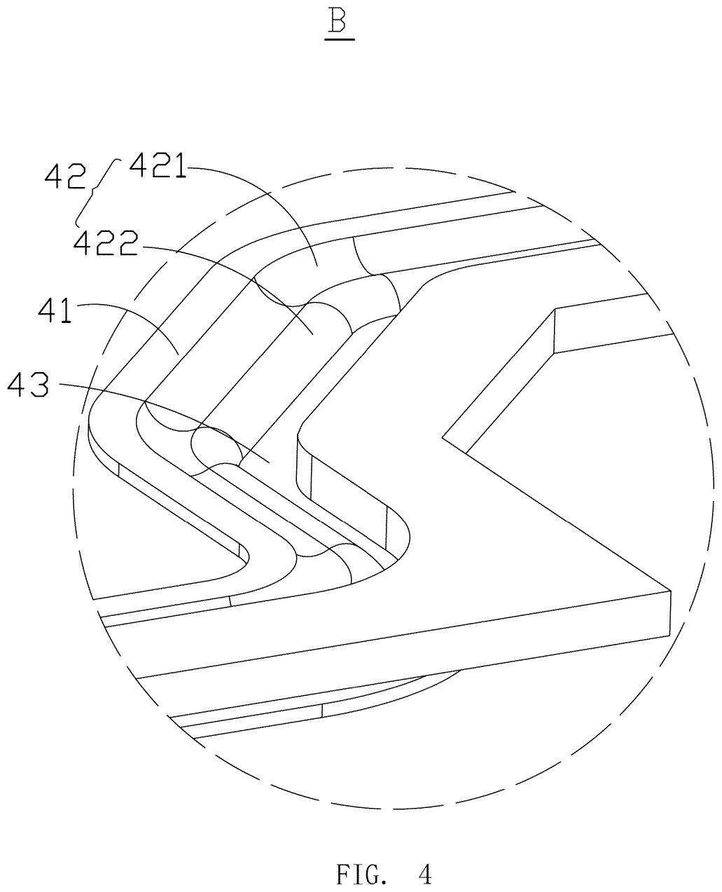

As an embodiment, please refer to FIGS. 4 and 5, the elastic connection member 40 includes the first fixed connection portion 41, a first elastic portion 421 bending and extending from the periphery of the first fixed connection portion 41, a second elastic portion 422 bending and extending from the periphery of the first elastic portion 421 towards the side away from the first fixed connection portion 41, and the second fixed connection portion 43 bending and extending from the side of the second elastic portion 422 away from the first elastic portion 421. The first fixed connection portion 41 is penetrated to form a through hole 401, the first elastic portion 421 and the second clastic portion 422 are protruding arc-shaped structure, as an embodiment, the protruding directions of the first elastic portion 421 and the second elastic portion 422 are opposite. As an example, the first elastic portion 421 protrudes towards the side away from the magnetic circuit system 30, and the second elastic portion 422 protrudes towards the side facing the magnetic circuit system 30. The heights of the first fixed connection portion 41, the first clastic portion 421, the second elastic portion 422, and the second fixed connection portion 43 are distributed in a stepped manner along the vibration direction of the vibration system 20. The magnetic yoke 31 covers the through hole 401 and connects to the first fixed connection portion 41, and the second fixed connection portion 43 connects to the basin frame 10.

In this embodiment, the voice coil 23 interacts with the magnetic circuit system 30 to make the vibration system 20 to vibrate and produce sound, the magnetic circuit system 30 is suspended by the clastic connection member 40, therefore, the magnetic circuit system 30 vibrates, and the direction the magnetic circuit system 30 vibrates is opposite to the vibration direction of the vibration system 20, the magnetic circuit system 30 and the vibration system 20 cooperatively form two suspension systems. The excitation of the two suspension systems is mutual action and reaction force with each other, so that when the speaker 100 is connected to a terminal device to use, the force is reduced to play a certain vibration damping effect, so as to avoid the problem of shell vibration.

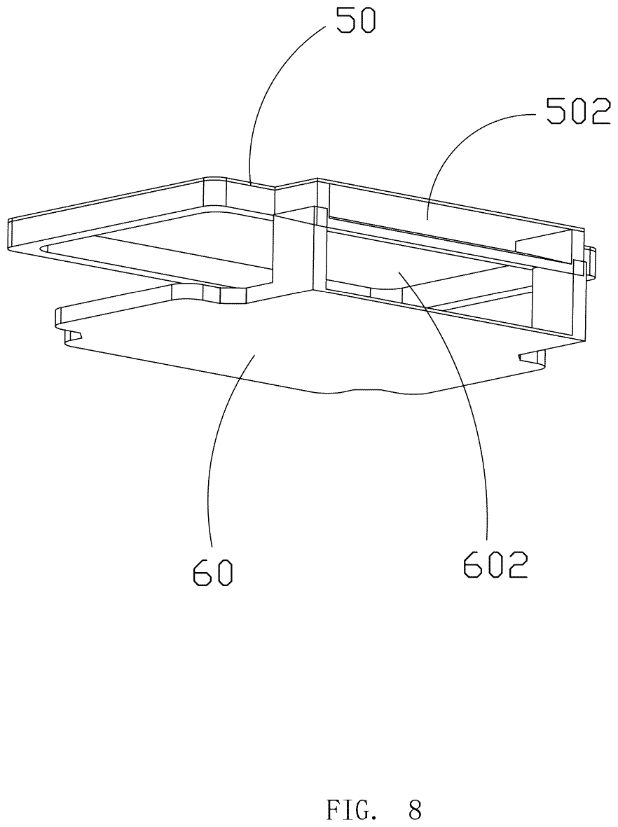

Further, please refer to FIGS. 2, 3, and 8, the speaker 100 also includes an upper housing 50 and a lower housing 60 fixed to opposite sides of the basin frame 10, the upper housing 50 and the lower housing 60 are respectively fixed to opposite sides of the basin frame 10, the upper housing 50, the diaphragm 21, and the basin frame 10 surround cooperatively form a first front cavity 1002 for sound output from the vibration system, the lower housing 60, the magnetic yoke 31, and the basin frame 10 surround cooperatively form a second front cavity 1003 for sound output from the vibration of the magnetic yoke 31. Further, the upper housing 50 is provided with a first sound outlet 502 for connecting the first front cavity 1002 and the outside world, the lower housing 60 is connected to the upper housing 50, and the upper housing 50 and the lower housing 60 cooperatively form a second sound outlet 602 for connecting the second front cavity 1003 and the outside world. In this embodiment, please refer to FIG. 6. The upper housing 50 and the lower housing 60 are mutually fixed so that the first sound outlet 502 and the second sound outlet 602 are combined and connected to a terminal device, achieving dual-sided sound output for the speaker 100, and reducing vibration while enhancing sound sensitivity.

Further, the clastic connection member 40 is made of one or more of a monomer damping material, a polymer composite damping material, or a metal composite damping structure.

It should be noted that the materials are used for the elastic connection member 40, such as the monomer damping material, the polymer composite damping material, and the metal composite damping structure, are conventional materials used in the field for resilient structures, these materials are used to adjust the damping elasticity.

Among them, the monomer damping material is damping rubber and/or foam sponge. The clastic connection member 40 is fixed to the basin frame 10 and the magnetic yoke 31 by means of adhesive bonding fixation. The damping rubber and the foam sponge are conventional materials used in the field for resilient structures.

Among them, the metal composite damping structure is high damping metal and/or constrained layer damping structure. When the clastic connection member 40 is the metal composite damping structure, the elastic connection member 40 is fixed to the basin frame 10 and the magnetic yoke 31 by means of adhesive bonding fixation and/or electro-thermal welding. The high damping metal and the constrained layer damping structure are conventional materials used in the field for resilient structures.

Among them, the polymer composite damping material is particle-doped fiber-doped and/or laminated composite materials. When the elastic connection member 40 is the polymer composite damping material, the elastic connection member 40 is fixed to the basin frame 10 and the magnetic yoke 31 by means of adhesive bonding and/or ultrasonic welding. The particle-doped fiber-doped and the laminated composite materials are conventional materials used in the field for elastic structures.

The above is only the preferred embodiments of the present invention. It should be noted that those of ordinary skill in the art can further make improvements without departing from the concept of the present invention. These improvements shall all fall within the protection scope of the present invention.

What is claimed is:

1. A speaker, comprising:
a basin frame;
a vibration system and a magnetic circuit system respectively fixed to the basin frame, the magnetic circuit system configured for driving the vibration system to vibrate and produce sound, the vibration system comprising a diaphragm fixed to the basin frame, and the magnetic circuit system comprising a magnetic yoke supported by and fixed to the basin frame;
an elastic connection member connecting the magnetic yoke and the basin frame to support the vibration of the magnetic circuit system, the diaphragm, the magnetic yoke, the basin frame, and the elastic connection member being sealed and surrounded to form a back cavity; vibration directions of the magnetic circuit system and the vibration system being opposite;
an upper housing and a lower housing respectively fixed on opposite sides of the basin frame, the upper housing, the diaphragm, and the basin frame cooperatively forming a first front cavity for sound output, and the lower housing, the magnetic yoke, and the basin frame cooperatively forming a second front cavity for sound output.

2. The speaker according to claim 1, wherein the upper housing is provided with a first sound outlet for connecting the first front cavity to the outside world, the lower housing is connected to the upper housing, and the upper housing and the lower housing cooperatively form a second sound outlet for connecting the second front cavity to the outside.

3. The speaker according to claim 1, wherein the elastic connection member comprises a first fixed connection portion connected to the magnetic yoke, an elastic portion extending from the periphery of the first fixed connection portion, a second fixed connection portion bending and extending from the side of the elastic portion away from the first fixed connection portion, and the second fixed connection portion is connected to the basin frame.

4. The speaker according to claim 1, wherein the elastic connection member is made of one or more of a monomer damping material, a polymer composite damping material, and a metal composite damping structure.

5. The speaker according to claim 1, wherein the magnetic circuit system comprises a main magnet fixed to the magnetic yoke, a secondary magnet spaced apart from the main magnet to form a magnetic gap, a main pole plate covering the side of the main magnet away from the magnetic yoke; the main magnet is penetrated at a center thereof to form a first cavity, the main pole plate is penetrated at a center thereof to form a second cavity, the first cavity and the second cavity are connected; the magnetic circuit system further comprises a magnetic assembly at least partially received in the first cavity, and a connection element connects the magnetic assembly and the diaphragm via the second cavity.

6. The speaker according to claim 5, wherein the magnetic yoke is penetrated at a center thereof to form an opening hole, and the first cavity, the second cavity, and the opening hole are coaxially arranged.

7. The speaker according to claim 5, wherein the magnetic assembly comprises a first magnetic part received in the first cavity and is connected to the side of the connection element away from the diaphragm.

8. The speaker according to claim 7, wherein the magnetic assembly comprises a second magnetic part fixed to the magnetic yoke and located in the first cavity; the second magnetic part is penetrated to forma third cavity, the third cavity is coaxially arranged with the second cavity; and the first magnetic part is received in the third cavity and is spaced apart from the second magnetic part.

9. The speaker according to claim 5, wherein the connection element is made of a non-magnetic conductive material.

10. The speaker according to claim 8, wherein the first magnetic part is a magnet, and the second magnetic part is the magnet, a magnetic portion, a magnetic conductive material or a structure formed by alternating layers of magnetic conductive material and non-magnetic conductive material.

11. The speaker according to claim 5, wherein the basin frame comprises a body portion having a receiving space, and an extension portion received in the receiving space and extending from the body portion, the magnetic yoke and the diaphragm are fixed to the basin frame at opposite ends along the vibration direction of the vibration system, and the extension portion covers the side of the secondary magnet away from the magnetic yoke.
